(19) United States
(12) Patent Application Publication
(10) Pub. No.: US 2008/0119178 A1
(43) Pub. Date: May 22, 2008

(54) Allocating Compression-Based Firmware Over the Air

(75) Inventors: Sudheer Kumar Peddireddy, Garland, TX (US); Vani Budhati, Garland, TX (US)

Correspondence Address: CONLEY ROSE, P.C., 5601 GRANITE PARKWAY, SUITE 750, PLANO, TX, 75024, US

(73) Assignee: SAMSUNG ELECTRONICS CO., LTD., Kyungki-do (KR)

(21) Appl. No.: 11/773,920

(22) Filed: Jul. 5, 2007

Related U.S. Application Data
(60) Provisional application No. 60/866,760, filed on Nov. 21, 2006.

(51) Int. Cl. G06F 9/445

(52) U.S. Cl. 455/418

(57) ABSTRACT

Computer readable medium, a system, and a method for providing an image for use in a mobile device are provided. Object files are selected that include at least some code and some data for use by the mobile device. Components are generated from the object files. A size of a component is divided by a size of a logical block to determine a number of logical blocks to allocate for the component. The number of logical blocks to allocate for the component is rounded up to an integer multiple of the size of the logical block. A unique address is established for each component based on the integer multiple of the size of the logical block. A memory layout is generated including each unique address. Each component is loaded at its corresponding unique address to provide the image.

### CROSS-REFERENCE TO RELATED APPLICATIONS

This application claims priority from U.S. Provisional Patent Ser. No. 60/866,760, filed Nov. 21, 2006, entitled “System and Method for Compression-Based Firmware Over the Air” which is incorporated herein by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Mobile devices contain software in the form of executable instructions and non-executable data that are stored in a memory. The software provides mobile devices with the ability to perform various functions, such as communicating via a wireless network, handling call features such as call waiting and call forwarding, and maintaining calendars and address books, for example.

However, once an end user has a mobile device, providing additional software or making corrections to the software already installed on the mobile device is difficult. To address this problem, firmware over the air (FOTA) was developed to enable a service provider to send or provide software updates over a wireless network to a mobile device. Such updates may provide additional functionality to software already existing on the mobile device or may provide bug fixes to address problems with the existing software. However, while an update process such as FOTA presents a way to send software to a mobile device, using such an update process is not without problems.

### SUMMARY

In one embodiment, computer readable medium is provided containing software instruction operable when executed for providing an image for use in a mobile device. Object files are selected that include at least some code and some data for use by the mobile device. Components are generated from the object files. A size of a component is divided by a size of a logical block to determine a number of logical blocks to allocate for the component. The number of logical blocks to allocate for the component is rounded up to an integer multiple of the size of the logical block. A unique address is established for each component based on the integer multiple of the size of the logical block. A memory layout is generated including each unique address. Each component is loaded at its corresponding unique address to provide the image.

In another embodiment, a system for providing an image for use in a mobile device is provided. The system includes an image creation system and a mobile device. The image creation system includes a processor. The mobile device includes a processor and a FOTA engine. The image creation system selects object files that include at least some code and some data for use by the mobile device. The image creation system also generates components from the object files. The FOTA engine divides a size of a component by a size of a logical block to determine a number of logical blocks to allocate for the component, and rounds up the number of logical blocks to allocate for the component to an integer multiple of the size of the logical block. The FOTA engine also establishes a unique address for each component based on the integer multiple of the size of the logical block, and generates a memory layout including each unique address. Additionally, the FOTA engine loads each component at its corresponding unique address to provide the image.

In yet another embodiment, a method for updating an image for use in a mobile device is provided. Object files are selected that include at least some code and some data for use by the mobile device. Components are generated from the object files. A size of a component is divided by a size of a logical block to determine a number of logical blocks to allocate for the component. The number of logical blocks to allocate for the component is rounded up to an integer multiple of the size of the logical block. A delta is created between the object files and original object files. At least one updated component is generated from the delta and an original component. A unique address is established for each updated component based on the integer multiple of the size of the logical block. A memory layout is generated including each unique address. Each updated component is loaded at its corresponding unique address to provide an updated image.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 shows a system for providing an image for use in a mobile device according to embodiments of the present disclosure.

FIGS. 2A-2D show various embodiments of memory blocks containing an image according to embodiments of the present disclosure.

FIG. 3 shows a flow chart of a method for providing an image for use in a mobile device according to embodiments of the present disclosure.

FIG. 4 shows a flow chart of a method for updating an image for use in a mobile device according to embodiments of the present disclosure.

FIG. 5 shows an illustrative wireless communications system.

FIG. 6 shows a block diagram of an illustrative mobile device.

FIG. 7 shows a diagram of an illustrative software configuration for a mobile device.

FIG. 8 shows block diagram of a typical, general-purpose computer system suitable for implementing one or more embodiments disclosed herein.

### DETAILED DESCRIPTION OF THE PREFERRED EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents. This application is related to and incorporates by reference for all purposes U.S. patent application Ser. No. ______, entitled “Partitioning Compression-Based Firmware Over The Air” by Sudheer K. Peddireddy, and filed on even date herewith.

Methods and systems for FOTA providing a compressed image for use in a mobile device are provided. In the present disclosure, the size of memory for a compressed component to be FOTA provided to a mobile device is determined. This size of memory is divided by the size of a logical block, which may be the minimal amount of memory that can be written to a flash memory, to determine the approximate number of logical blocks of memory to be allocated for the compressed component. The approximate number of logical block of memory to be allocated is rounded up to the next highest integer multiple of logical blocks to determine the actual size of memory to allocate for the compressed component. Such an allocation of logical blocks results in each compressed component being loaded in memory from one logical block boundary to another logical block boundary, thereby eliminating problems that arise when any logical block includes different compressed components. When fewer compressed components straddle logical block boundaries, the number of logical block writes and logical block reads is minimized. When a new compressed component is written and it overwrites the next compressed component, the next compressed component must be rewritten as well, which can cause a domino effect that slows the update process significantly. Fewer reads and writes provide the user of the mobile device with faster FOTA update times and quicker access to compressed components and modules. In the current embodiments, compressed components are each loaded at unique addresses based on integer multiples of the size of a logical block. A memory layout can be used by the mobile device to efficiently write, locate, retrieve, decompress, and execute compressed components.

In some embodiments, instead of spending significant time FOTA sending all of a new compressed component, only the portions of the new compressed component that differ from the old compressed component are FOTA sent to the mobile device, thereby saving updating time. Updated compressed components are loaded to the mobile device considering the changes to the old compressed component. Each updated compressed component is loaded at a unique address based on an integer multiple of the number of logical blocks rounded up from the number of logical blocks required for the updated compressed component. A memory layout can be used by the mobile device to efficiently write, locate, retrieve, decompress, and execute compressed components.

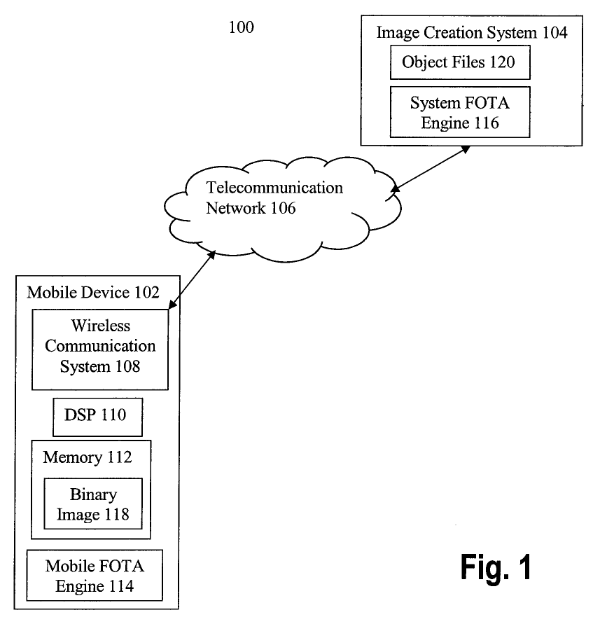

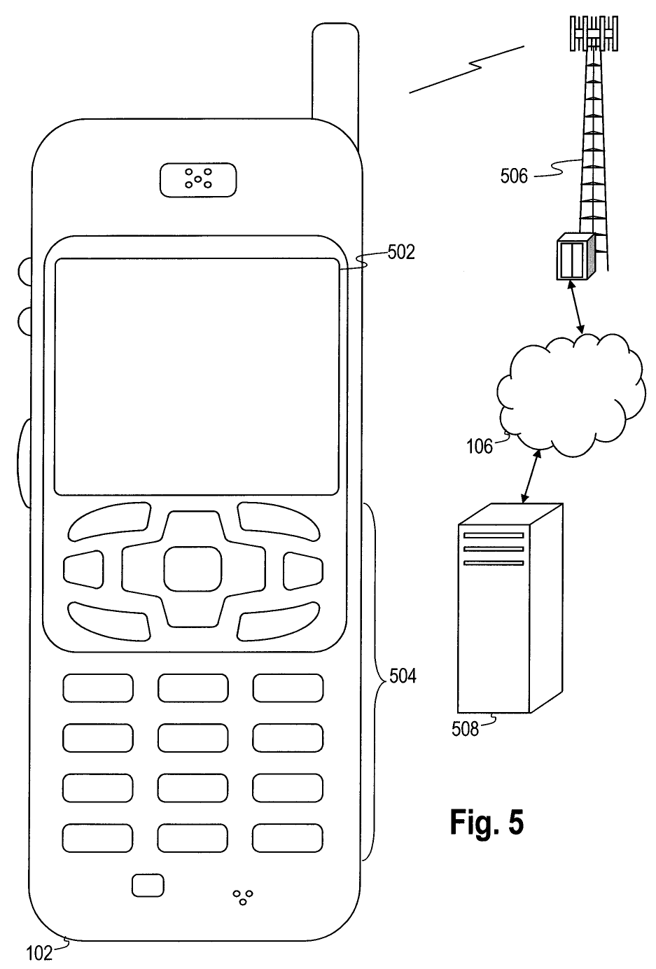

FIG. 1 depicts a system 100 for providing an image for use in a mobile device according to embodiments of the present disclosure. The system 100 includes a mobile device 102, which is described in more detail below with reference to FIGS. 5-7, an image creation system 104, and a telecommunication network 106, by which the mobile device 102 and the image creation system 104 communicate with each other. The system 100 shows only one mobile device, one image creation system, and one telecommunication network for the purposes of an illustrative example, but the system 100 may include any number of mobile devices, image creation systems, and telecommunication networks.

The telecommunication network 106 may be a wireless telecommunication network, a public switch telephone network, an internet, or other networks, or combinations thereof. The telecommunication network 106 may be any type of network, including centralized and ad hoc networks, and may use any type of network technology, including Code Division Multiple Access (CDMA), Global System for Mobile communication (GSM), Orthogonal Frequency Division Multiplexing (OFDM), or similar communications technologies. In the present example, the telecommunication network 106 is a packet-based network, but it is understood that the present disclosure applies to any type of transmission.

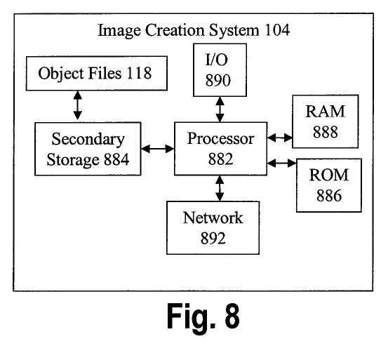

As will be described below in greater detail in FIG. 8, the image creation system 104 provides functionality to create an image containing executable instructions and/or data. The image is transferred via the telecommunication network 106 to the mobile device 102. The mobile device 102 can use the image to provide functionality to a user and communicate with other devices via the telecommunication network 106. The image may contain various combinations of functionality and data. The image creation system 104 may update the image with additional features and bug fixes.

The mobile device 102 includes a wireless communication system 108 that the mobile device 102 uses to communicate with the telecommunications network 106. The mobile device 102 also includes a digital signal processor (DSP) 110, a memory 112, and a mobile FOTA engine 114 that are used to provide an image for use by the mobile device 102. The image creation system 104 can also include a system FOTA engine 116 to prepare binary images sent to the mobile device 102. The image creation system 104 may use the system FOTA engine 116 to select object files, partition some object files into modules, generate components from the object files and any modules, determine the number of logical blocks to allocate for each component and module, and transfer the components and any modules to the mobile device 102. The mobile device 102 can use the DSP 110 to execute instructions in the image. The mobile device 102 can be any mobile device, including cellular phones, personal digital assistants, and laptop computers. An operating system may be used by the DSP 110 to control the mobile device 102 and provide a user interface by which a user of the mobile device 102 can access and utilize various functions.

The memory 112 of the mobile device 102 includes a binary image 118 of the executable instructions and data contained within the mobile device 102, although not all instructions and data in the mobile device 102 may be included in the binary image 118. In the present example, the binary image 118 is a monolithic image that contains the instructions and data in a static relationship that is created prior to being transferred to the mobile device 102. The binary image 118 is initially created by the image creation system 104 based on object files 120. The term “file” may represent any type of object, including text files, script files, or code in source, assembly, or other coding or language. A software program is generally written using a high level language (i.e., source code) and converted into machine readable language (i.e., object code) that is stored in files. The image creation system 104 examines the machine language code in the object files 120 to identify similarities between various pieces of code and then, unless otherwise directed, builds components based on those similarities. A component may contain a single module or a collection of modules, where a module can be a portion of a component that may be a relocatable object file. The component may be instructions to operate particular features on the mobile device 102, such as an address book.

The mobile FOTA engine 114 can include a compression component that assists in the compressing of the binary image 118 received from the image creation system 104, which enables the mobile FOTA engine 114 to minimize the amount of the memory 112 required to store the binary image 118 in the mobile device 102. Because the user of the mobile device 102 may store data such as voice messages, text messages, pictures, e-mails, and contacts in the memory 112, minimizing the amount of the memory 112 required to store the binary image 118 provides more available memory for the user. The image creation system 104 may use the system FOTA engine 116 to compress components before transferring the components in the binary image 118 to the mobile device 102.

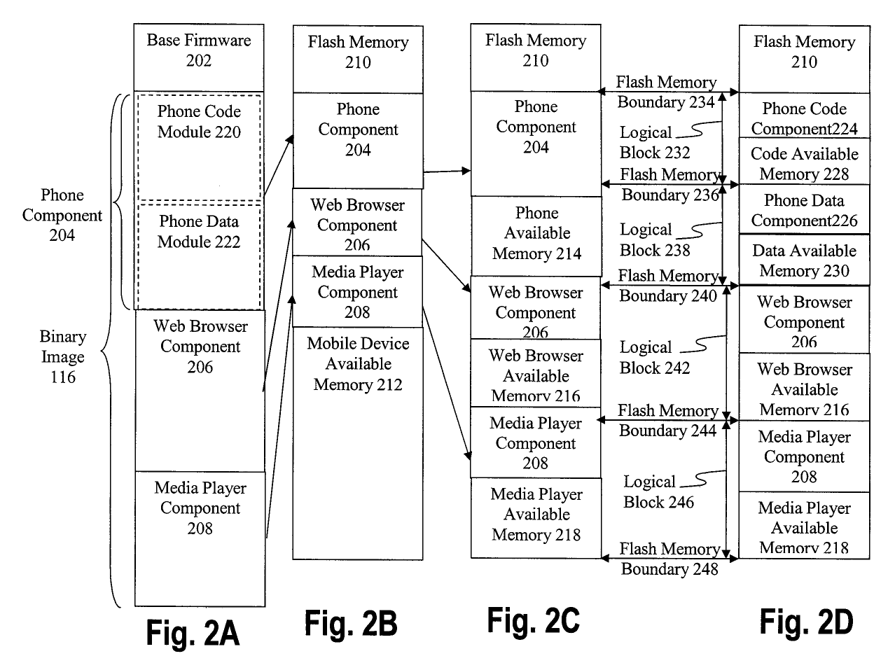

The use of the binary image 118 creates a number of problems when updating the mobile device 102. The problems often stem from image updates that occur when the binary image 118 present on the mobile device 102 is updated to become a new image. When an image update occurs, the differences between the binary image 118 on the mobile device 102 and the new image that is to be transferred to the mobile device 102 are referred to as the image delta (e.g., the amount of change) between the two images. Examples of such problems are discussed below in reference to FIGS. 2A-2D.

Turning now to FIG. 2A-2D, memory blocks containing the binary image 118 are depicted according to some embodiments of the present disclosure. In FIG. 2A, the binary image 118 is stored in base firmware 202, and includes a phone component 204, a web browser component 206, and a media player component 208. The phone component 204, the web browser component 206, and the media player component 208 are illustrative examples only, as the binary image 118 can be composed of any types of binary components. For example, the binary image may also be composed of components for a phone book, messaging, a calendar, and games. The base firmware 202 is developed in the image creation system 104. The components 204, 206, and 208 are depicted for purposes of illustration only, as any combination or organization of instructions and data may be provided. As illustrated, each component 204, 206, and 208 of the binary image 118 abuts the next component.

In FIG. 2B, the binary image 118 is stored in flash memory 210, and includes the phone component 204, the web browser component 206, the media player component 208, and mobile device available memory 212. The mobile device available memory 212 is memory that is reserved in the flash memory 210 for future expansion of the components 204-208 in the binary image 118. The components 204-208 in FIG. 2B appear smaller than the components 204-208 in FIG. 2A because the mobile FOTA engine 114 compresses components in the flash memory 210 to minimize the amount of memory required to store the binary image 118 in the mobile device 102.

Because the binary image 118 is a fixed binary representation of the instructions and data, the location of each component 204-208 is static once the binary image 118 is stored in the flash memory 210. The static nature of each location makes providing incremental updates to the binary image 118 difficult, because if any component other than the media player component 208 is expanded, there is no available memory in which the update can be stored contiguously with the portion being updated.

For example, the phone component 204 is associated with a fixed location when the binary image 118 is provided. However, an update to the binary image 118 may result in an expansion of the phone component 204 beyond the location where the phone component 204 previously ended, overlapping into the location where the beginning of web browser component 206 is stored. Overwriting a portion of the expanded phone component 204 over the web browser component 206 may result in corrupting the web browser component 206. The expansion of the phone component 204 into the location occupied by the web browser component 206 requires that the web browser component 206 be written again in its entirety at a new location beyond the end location of the expanded phone component 204. However, shifting the beginning location of the web browser component 206 also results in shifting the ending location of the web browser component 206 into the location occupied by the media player component 208. Therefore, the expansion of the phone component 204 can result in the shifting of not only the web browser component 206, but also the shifting of the media player component 208, and every other component in the flash memory 210 that is stored contiguously after the phone component 204. Accordingly, this problem in propagating changes throughout the binary image 118 while performing incremental updates may cause serious problems in the operation of the mobile device 102.

In FIG. 2C, the binary image 118 is stored in flash memory 210, and includes the phone component 204, the web browser component 206, the media player component 208, phone available memory 214, web browser available memory 216, and media player available memory 218. When loaded in the flash memory 210, the binary image 118 is broken into various portions (e.g., the components 204, 206, and 208) and each portion is assigned a block of available memory (e.g., the available memories 214, 216, and 218). For example, there is a phone available memory 214 that is contiguous to and follows the phone component 204. The mobile device available memory 212 from FIG. 2B is divided into three smaller portions of memory, the phone available memory 214, the web browser available memory 216, and the media player available memory 218. The available memory portions allow for some expansion of the components 204, 206, and 208 without the need to rewrite the entire binary image 118.

The solution of putting available memory between components may be feasible in some situations, but may not necessarily solve all the propagation problems in other situations, such as when the update requires more available memory for a component than has been reserved for the component. For example, some available memory may overflow relatively quickly due to updates and bug fixes, which can result in having to rewrite almost the entire binary image 118 in the flash memory 210 even when only a small amount of the binary image 118 is updated. Often, there may be little flexibility available for the software represented by the binary image 118. The binary image 118 is created using the image creation system 104 outside of the mobile device 102 and then transferred to the mobile device 102 when the binary image 118 is complete. Because of the relatively simple operating system in the mobile device 102 and the use of the binary image 118, updates such as additional features and bug fixes may require that the entire binary image 118 be modified and transferred to the mobile device 102. This is often impractical for a number of reasons. Not only is it impractical to utilize a customer's bandwidth for a lengthy period of time, but governmental regulations may limit the amount of time that an update may take. For example, governmentally mandated 911 restrictions may require that an update take no more than five minutes. As such, updating large portions of an existing binary image 118 on the mobile device 102 is often unfeasible.

Embodiments of the present disclosure address these updating problems by allocating memory to each component based on logical block boundaries to minimize the number of logical blocks written and read for each component. If the mobile FOTA engine 114 compresses the phone component 204 to a size that is larger than one logical block, the phone component 204 must be stored in more than one logical block. However, by rounding up the number of logical blocks for the phone component 204 to an integer multiple of the size of the logical blocks, the logical blocks reserved for the phone component 204 to expand will not include any portions of a subsequent component. This rounding up increases the probability that if any part of the phone component 204 is updated, then the subsequent modification of the logical blocks storing the phone component 204 will only modify the phone component 204, and will not modify any other component. Modifying additional components requires more update time and consumes more processing resources than modifying the minimum number of components, thereby creating a propagation problem.

Additionally, components that are compressed to a size that is larger than a logical block may be partitioned into smaller modules that can be smaller than a logical block. For example, when the mobile FOTA engine 114 compresses the phone component 204 for the flash memory 210, the phone component 204 is larger than 16 k, or one logical block. Therefore, the phone component 204 is partitioned into modules, such as a phone code module 220 and a phone data module 222 depicted in FIG. 2A. Each smaller module may fit in only one logical block in the flash memory 210. The phone code module 220 and the phone data module 222 are depicted as examples only, as the phone component 204 can be partitioned into other modules as well, and any component may be partitioned into modules.

In FIG. 2D, the binary image 118 is stored in flash memory 210, and includes the web browser component 206, the media player component 208, the web browser available memory 216, the media player available memory 218, a phone code component 224, a phone data component 226, a code available memory 228, and a data available memory 230. The phone code component 224 and the phone data component 226 are generated from the phone code module 220 and the phone data module 222 that are part of the phone component 204. The phone code module 220 and the phone data module 222 are depicted as examples only, as the phone component 204 can be partitioned into other modules and other components can also be partitioned into modules.

The phone code component 224 and the code available memory 228 are stored in a logical block 232 that is located from a flash memory boundary 234 to a flash memory boundary 236. The phone data component 226 and the data available memory 230 are stored in a logical block 238 that is located from the flash memory boundary 236 to a flash memory boundary 240. The web browser component 206 and the web browser available memory 216 are stored in a logical block 242 that is located from the flash memory boundary 240 to a flash memory boundary 244. The media player component 208 and the media player available memory 218 are stored in a logical block 246 that is located from the flash memory boundary 244 to a flash memory boundary 248. By storing the components and their available memories in the flash memory 210 based on flash memory blocks 232, 238, 242, and 246, propagation problems are minimized.

These propagation problems become apparent when the locations of the components in FIG. 2C are compared to the locations of the logical blocks 232, 238, 242, and 246. For example, the web browser component 206 and the web browser available memory 216 are stored in the flash memory 210 at a location before the flash memory boundary 240 to a location before the flash memory boundary 244, where the media player component 208 begins. Therefore, part of the web browser component 206 is stored in the logical block 238 and the rest of the web browser component 206 is stored in the logical block 242. If any portion of the web browser component 206 is updated in the base firmware 202, the corresponding logical blocks in the flash memory 210 are rewritten. The mobile FOTA engine 114 compresses the web browser component 206 to a size that is smaller than the size of a logical block, such that one logical block write can rewrite the entire web browser component 206 in the flash memory 210. However, the web browser component 206 was not stored in FIG. 2C based on the flash memory boundaries 240 and 244. Therefore, the update of the web browser component 206 requires the rewriting of at least two logical blocks, the logical block 238 and the logical block 242, instead of rewriting only one logical block.

Furthermore, rewriting the logical block 242, which is required for updating the web browser component 206, also overwrites the part of the media player component 208 that is located before the flash memory boundary 244. Rewriting part of the media player component 208 can require the rewriting of the entire media player component 208, which means that the logical block 246 must also be rewritten. The propagation of rewriting components that are stored on both sides of a flash memory boundary can result in rewriting multiple logical blocks to update only one component that changed, even when that one component can easily be stored in only one logical block. Rewriting of only one updated component that is smaller than a logical block can require rewriting numerous subsequent components stored after the updated component, thereby creating writing propagation problems.

In contrast, the web browser component 206 was stored in FIG. 2D based on the flash memory boundaries 240 and 244. Therefore, the update of the web browser component 206 requires writing only one logical block, the logical block 242. Rewriting the logical block 242 does not overwrite any other component, and updating any other component does not overwrite any portion of the logical block 242.

To further minimize the number of logical block reads and logical block writes, components that are compressed to a size that is larger than one logical block may be partitioned into smaller modules. For example, because the phone code component 224 and its code available memory 228 are smaller than the phone component 204, the phone code component 224 and its code available memory 228 can both fit in only one logical block. Likewise, because the phone data component 226 and its data available memory 230 are smaller than the phone component 204, the phone data component 226 and its data available memory 230 can both fit in only one logical block. Any subsequent modification to the phone component 204 that affects only the phone code module 220 requires only updating the logical block 232 in the flash memory 210 that stores the phone code component 224, and does not require updating the logical block 238 in the flash memory 210 that stores the phone data component 226. Updating fewer logical blocks in the flash memory 210 requires less updating time and consumes less processing resources.

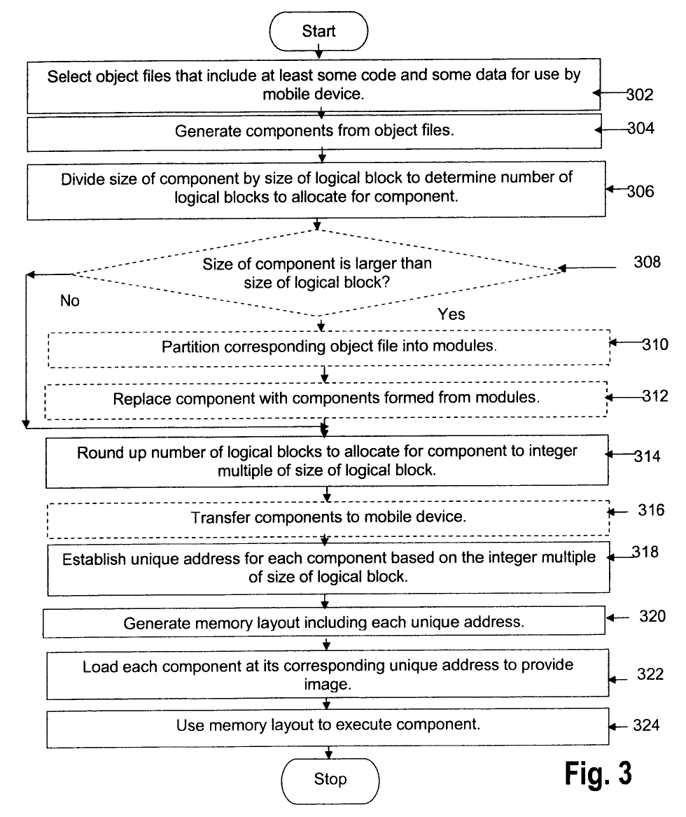

Turning now to FIG. 3 a flowchart of a method for providing an image for use in a mobile device is depicted according to an embodiment of the present disclosure. Executing the method enables the image creation system 104 to provide the binary image 118 to the mobile device 102.

In box 302, the image creation system selects object files that include at least some code and some data for use by the mobile device. For example, a user of the image creation system 104 enters data to select the object files 120 to be used to provide the binary image 118 for the mobile device 102. The identified object files 120 can include object files for the phone component 204, the web browser component 206, and the media player component 208, which are illustrative examples only, as the object files 120 can include any types of components, such as components for a phone book, messaging, a calendar, and games.

In box 304, the image creation system generates components from the object files. For example, the image creation system 104 generates the phone component 204, the web browser component 206, and the media player component 208 from the object files 120, wherein the object files 120 are provided in machine language. Each component may be a collection of modules, where each module is a relocatable object, and the collection may be predefined, such as an archive. For example, an archive, which can have a name of *.a or *.lib, may be a library that includes multiple modules, and the library itself may be identified as a component. Components may be based on user provided definitions, default definitions, or a combination of user provided and default definitions. For example, a default definition may define a component as a collection of related modules, such as a single library or other defined collection, with any non-library files combined into a single component. Accordingly, if there are two libraries and multiple non-library files, there would be three components. The user of the image creation system 104 can provide a component definition that may override any applicable default definition. For example, the user may combine multiple libraries into a single component, divide a library into multiple components, etc. User-defined and default definitions may be mixed, with a user defining certain components and allowing other components to be defined according to the default definitions.

In box 306, the image creation system divides a size of a component by a size of a logical block to determine a number of logical blocks to allocate for the component. For example, the image creation system 104 divides 18 k of memory, the size of the phone component 204, by 16 k of memory, a size of a logical block in the flash memory 210, to determine to allocate 1.125 logical blocks for the phone component 204. In another example, the image creation system 104 divides 8 k of memory, the size of the web browser component 206, by 16 k of memory, a size of a logical block in the flash memory 210, to determine to allocate 0.5 logical blocks for the web browser component 206.

In box 308, the image creation system optionally determines whether the size of a component is larger than the size of a logical block. If the image creation system 104 does not optionally determine whether the size of a component is larger than the size of a logical block, the method proceeds to box 314. For example, the image creation system 104 determines whether the size of the phone component 204 is larger than the 16 k memory size of each logical block in the flash memory 210. If the image creation system 104 determines that the size of the component is not larger than the size of each logical block, the method proceeds to box 314. If the image creation system 104 determines that the size of the component is larger than the size of each logical block, the method continues to box 310.

In box 310, the image creation system optionally partitions a corresponding object file into modules. For example, the image creation system 104 partitions the corresponding object files 120 for the phone component 204 into the phone code module 220 and the phone data module 222. The object files 120 enables a user to partition the binary image 118 into a number of separate code and data regions spread throughout a memory's address map. The processor 182 generates components, such as the phone component 204, into modules, such as the phone code module 220, based on the partitioned object files 120. The processor 182 may call another process to partition the object files 120 into components. One such process for partitioning the object files is described in greater detail in U.S. patent application Ser. No. ______ and entitled “System and Method for a Pseudo DLL Linker,” which is incorporated by reference for all purposes.

In box 312, the image creation system optionally replaces a component with components generated from modules. For example, the image creation system 104 replaces the phone component 204 in the list of generated components to be provided to the mobile device 102 with the phone code component 224 and the phone data component 226.

In box 314, the image creation system rounds up a number of logical blocks to allocate for a component to an integer multiple of a size of a logical block. For example, the image creation system 104 rounds up the 1.125 logical blocks to allocate for the phone component 204 to 2 logical blocks, an integer multiple of the size of each logical block in the flash memory 210. In another example, the image creation system 104 rounds up the 0.5 logical blocks to allocate for the web browser component 206 to 1 logical block, an integer multiple of each size of the logical block in the flash memory 210.

In box 316, the image creation system transfers components to the mobile device. For example, the image creation system 104 transfers the phone component 204, the web browser component 206, and the media player component 208 to the mobile device 102. Although FIG. 3 depicts the image creation system 104 transferring components to the mobile device 102 after rounding up the number of logical blocks to allocate for the component, the image creation system 104 can transfer components to the mobile device 102 after another box in the method. For example, the image creation system 104 can transfer components to the mobile device 102 after generating components from the object files 120, as described for box 304. For this example, instead of the image creation system 104 using the system FOTA engine to execute boxes 306 to 314, the mobile FOTA engine 114 can execute boxes 306 to 314.

In box 318, the mobile FOTA engine 114 establishes a unique address for each component based on the integer multiple of the size of the logical block. For example, the mobile FOTA engine 114 establishes the flash memory boundary 258 as the address for the web browser component 206. The address may be determined by examining an existing memory structure and any files that manage loading of files or components in a particular memory space. The address determination defines the ranges of addresses that are available in the hardware for the components. For example, the flash memory boundary 240 is selected as the address for the web browser component 206 because the entire web browser component 206 can be stored in the logical block 242 between the flash memory boundary 240 and the flash memory boundary 244, with the memory not occupied by the web browser component 206 reserved for the web browser available memory 216.

In box 320, the mobile FOTA engine 114 generates a memory layout including each unique address. For example, the mobile FOTA engine 114 generates a memory map including the unique addresses, such as logical block 242 for the web browser component 206 and the logical block 246 for the media player component 208.

In box 322, the mobile FOTA engine 114 loads each component at its corresponding unique address to provide the binary image. For example, the mobile FOTA engine 114 loads the web browser component 206 at the flash memory boundary 240.

In box 324, the mobile FOTA engine 114 uses a memory layout to execute the component. For example, the mobile FOTA engine 114 uses the memory map to locate the web browser component 206 at the flash memory boundary 240, retrieve the web browser component 206, decompress the web browser component 206, and execute the web browser component 206.

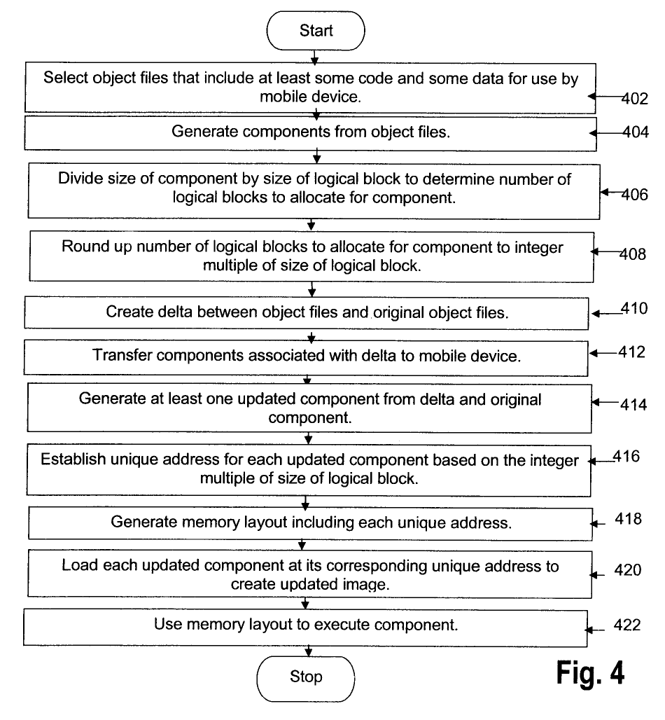

Turning now to FIG. 4 a flowchart of a method for updating an image for use in a mobile device is depicted according to an embodiment of the present disclosure. Executing the method enables the image creation system 104 to update the binary image 118 on the mobile device 102.

In box 402, the image creation system selects object files that include at least some code and some data for use by the mobile device. For example, the user of the image creation system 104 enters data to identify the object files 120 to be used to update the binary image 118 on the mobile device 102. The identified object files 120 can include object files for the phone component 204, the web browser component 206, and the media player component 208.

In box 404, the image creation system generates components from the object files. For example, the image creation system 104 generates the phone component 204, the web browser component 206, and the media player component 208 from the object files 120, wherein the object files 120 are provided in machine language.

In box 406, the image creation system divides a size of a component by a size of a logical block to determine a number of logical blocks to allocate for the component. For example, the image creation system 104 divides 18 k of memory, the size of the phone component 204, by 16 k of memory, the size of each logical block in the flash memory 210, to determine to allocate 1.125 logical blocks for the phone component 204.

In box 408, the image creation system rounds up a number of logical blocks to allocate for a component to an integer multiple of a size of a logical block. For example, the image creation system 104 rounds up the 1.125 logical blocks to allocate for the phone component 204 to 2 logical blocks, an integer multiple of the size of each logical block in the flash memory 210.

In box 410, the image creation system creates a delta between the object files and original object files. For example, the image creation system 104 compares the new components in the base firmware 202 with the original components and the original modules in the original base firmware. This comparison can create a delta between the object files 120 and original object files that specifies that the only changes to the components are changes to the phone component 204, changes that are identified as the phone delta.

In box 412, the image creation system transfers components associated with the delta to the mobile device. For example, the image creation system 104 transfers the phone delta to the mobile device 102.

In box 414, the mobile FOTA engine 114 generates an updated component from the delta and the original component. For example, the mobile FOTA engine 114 generates an updated phone code component 242 from the phone delta and an original phone code component. During the update process, the mobile FOTA engine 114 can write an additional copy of the original phone code component elsewhere in the flash memory to serve as a backup. Then the mobile FOTA engine 114 can decompress the original phone code component, incorporate the phone delta, compress the updated phone code component 224, and write the updated phone code component 224 to the logical block 232. The unused remainder of the logical block 232 is reserved for the code available memory 228. If a power failure or other problem interrupts the update process, the mobile FOTA engine 114 can retrieve the backup original phone code component written elsewhere in the flash memory, and restore the original phone code component at the logical block 232 for use until the update can be attempted again.

In box 416, the mobile FOTA engine 114 establishes a unique address for each component. For example, the mobile FOTA engine 114 establishes the flash memory boundary 234, where the logical block 232 begins, as the address for the updated phone code component 224. The amount of memory from the logical block 232 that the updated phone code component 224 does not use is reserved for the code available memory 228.

In box 418, the mobile FOTA engine 114 generates a memory layout including each unique address. For example, the mobile FOTA engine 114 generates the memory map including the unique addresses for the phone code component 224, the phone data component 226, the web browser component 206, and the media player component 208.

In box 420, the mobile FOTA engine 114 loads each updated component at its corresponding unique address to update the binary image. For example, the mobile FOTA engine 114 loads the updated phone code component 224 at the flash memory boundary 234 to update the binary image 118.

In box 422, the mobile FOTA engine 114 uses a memory layout to execute the updated component. For example, the mobile FOTA engine 114 uses the memory map to locate the updated phone code component 224 at the flash memory boundary 234, retrieve the updated phone code component 224, decompress the updated phone code component 224, and execute the updated phone code component 224.

FIG. 5 shows a wireless communications system including the mobile device 102. FIG. 5 depicts the mobile device 102, which is operable for implementing aspects of the present disclosure, but the present disclosure should not be limited to these implementations. Though illustrated as a mobile phone, the mobile device 102 may take various forms including a wireless mobile device, a pager, a personal digital assistant (PDA), a portable computer, a tablet computer, a laptop computer, a digital camera, a digital music player, a digital calculator, and an electronic key fob for keyless entry. Many suitable mobile devices combine some or all of these functions. In some embodiments of the present disclosure, the mobile device 102 is not a general-purpose computing device like a notebook or tablet computer, but rather is a special-purpose communications device such as a mobile phone, pager, or PDA.

The mobile device 102 includes a display 502 and a touch-sensitive surface or keys 504 for input by a user. The mobile device 102 may present options for the user to select, controls for the user to actuate, and/or cursors or other indicators for the user to direct. The mobile device 102 may further accept data entry from the user, including numbers to dial or various parameter values for configuring the operation of the mobile device. The mobile device 102 may further execute one or more software or firmware applications in response to user commands. These applications may configure the mobile device 102 to perform various customized functions in response to user interaction.

Among the various applications executable by the mobile device 102 are a web browser, which enables the display 502 to show a web page. The web page is obtained via wireless communications with a cell tower 506, a wireless network access node, or another wireless communications network or system. The cell tower 506 (or wireless network access node) is coupled to the telecommunication network 106, such as the Internet. Via the wireless link and the wired network, the mobile device 102 has access to information on various servers, such as a content server 508. The content server 508 may provide content that may be shown on the display 502.

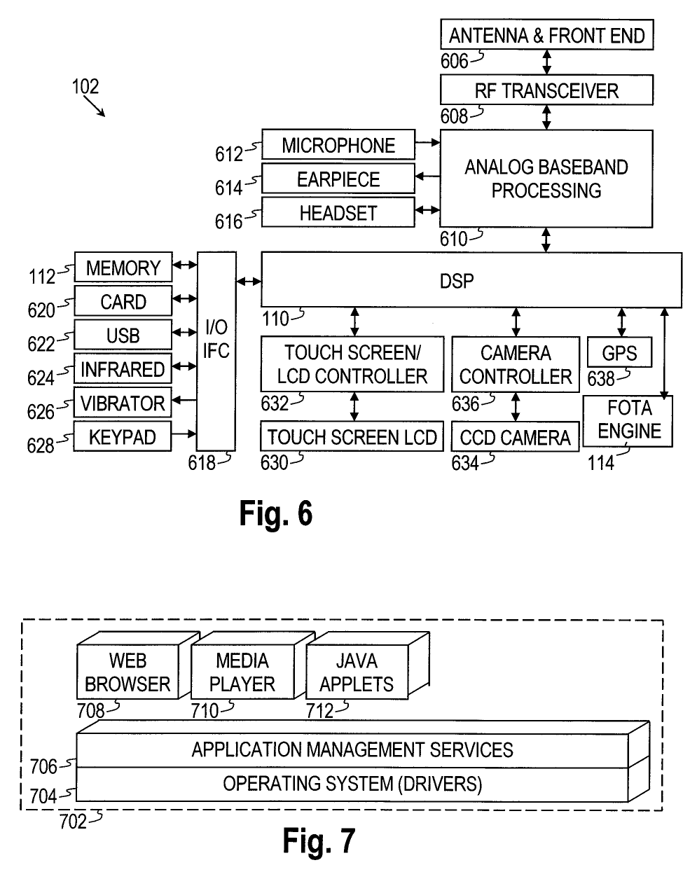

FIG. 6 shows a block diagram of the mobile device 102. The mobile device 102 includes the DSP 110 and the memory 112. As shown, the mobile device 102 may further include an antenna and front end unit 606, a radio frequency (RF) transceiver 608, an analog baseband processing unit 610, a microphone 612, an earpiece speaker 614, a headset port 616, an input/output interface 618, a removable memory card 620, a universal serial bus (USB) port 622, an infrared port 624, a vibrator 626, a keypad 628, a touch screen liquid crystal display (LCD) with a touch sensitive surface 630, a touch screen/LCD controller 632, a charge-coupled device (CCD) camera 634, a camera controller 636, a global positioning system (GPS) sensor 638, and the mobile FOTA engine 114.

The DSP 110 or some other form of controller or central processing unit operates to control the various components of the mobile device 102 in accordance with embedded software or firmware stored in the memory 112. In addition to the embedded software or firmware, the DSP 110 may execute other applications stored in the memory 112 or made available via information carrier media such as portable data storage media like the removable memory card 620 or via wired or wireless network communications. The application software may comprise a compiled set of machine-readable instructions that configure the DSP 110 to provide the desired functionality, or the application software may be high-level software instructions to be processed by an interpreter or compiler to indirectly configure the DSP 110.

The antenna and front end unit 606 may be provided to convert between wireless signals and electrical signals, enabling the mobile device 102 to send and receive information from a cellular network or some other available wireless communications network. The RF transceiver 608 provides frequency shifting, converting received RF signals to baseband and converting baseband transmit signals to RF. The analog baseband processing unit 610 may provide channel equalization and signal demodulation to extract information from received signals, may modulate information to create transmit signals, and may provide analog filtering for audio signals. To that end, the analog baseband processing unit 610 may have ports for connecting to the built-in microphone 612 and the earpiece speaker 614 that enable the mobile device 102 to be used as a cell phone. The analog baseband processing unit 610 may further include a port for connecting to a headset or other hands-free microphone and speaker configuration.

The DSP 110 may send and receive digital communications with a wireless network via the analog baseband processing unit 610. In some embodiments, these digital communications may provide Internet connectivity, enabling a user to gain access to content on the Internet and to send and receive e-mail or text messages. The input/output interface 618 interconnects the DSP 110 and various memories and interfaces. The memory 112 and the removable memory card 620 may provide software and data to configure the operation of the DSP 110. Among the interfaces may be the USB interface 622 and the infrared port 624. The USB interface 622 may enable the mobile device 102 to function as a peripheral device to exchange information with a personal computer or other computer system. The infrared port 624 and other optional ports such as a Bluetooth interface or an IEEE 802.11 compliant wireless interface may enable the mobile device 102 to communicate wirelessly with other nearby mobile devices and/or wireless base stations.

The input/output interface 618 may further connect the DSP 110 to the vibrator 626 that, when triggered, causes the mobile device 102 to vibrate. The vibrator 626 may serve as a mechanism for silently alerting the user to any of various events such as an incoming call, a new text message, and an appointment reminder.

The keypad 628 couples to the DSP 110 via the interface 618 to provide one mechanism for the user to make selections, enter information, and otherwise provide input to the mobile device 102. Another input mechanism may be the touch screen LCD 630, which may also display text and/or graphics to the user. The touch screen LCD controller 632 couples the DSP 110 to the touch screen LCD 630.

The CCD camera 634 enables the mobile device 102 to take digital pictures. The DSP 110 communicates with the CCD camera 634 via the camera controller 636. The GPS sensor 638 is coupled to the DSP 110 to decode global positioning system signals, thereby enabling the mobile device 102 to determine its position. In some embodiments, the mobile FOTA engine 114 might be a firmware component, a hardware component, or a combination of software, firmware, and/or hardware. Various other peripherals may also be included to provide additional functions, e.g., radio and television reception.

FIG. 7 illustrates a software environment 702 that may be implemented by the DSP 110. The DSP 110 executes operating system drivers 704 that provide a platform from which the rest of the software operates. The operating system drivers 704 provide drivers for the mobile device hardware with standardized interfaces that are accessible to application software. The operating system drivers 704 include application management services (“AMS”) 706 that transfer control between applications running on the mobile device 102. Also shown in FIG. 7 are the web browser application 708, a media player application 710, and Java applets 712. The web browser application 708 configures the mobile device 102 to operate as a web browser, allowing a user to enter information into forms and select links to retrieve and view web pages. The media player application 710 configures the mobile device 102 to retrieve and play audio or audiovisual media. The Java applets 712 configure the mobile device 102 to provide games, utilities, and other functionality.

The image creation system 104 may be implemented on any general-purpose computer with sufficient processing power, memory resources, and network throughput capability to handle the necessary workload placed upon it. FIG. 8 illustrates a typical, general-purpose computer system suitable for implementing one or more embodiments disclosed herein. The image creation system 104 includes a processor 882 (which may be referred to as a central processor unit or CPU) that is in communication with memory devices including secondary storage 884, read only memory (ROM) 886, random access memory (RAM) 888, input/output (I/O) 890 devices, network connectivity devices 892, and the object files 120. The processor 882 may be implemented as one or more CPU chips.

The secondary storage 884 is typically comprised of one or more disk drives or tape drives and is used for non-volatile storage of data and as an over-flow data storage device if the RAM 888 is not large enough to hold all working data. The secondary storage 884 may be used to store the object files 120 and programs that are loaded into the RAM 888 when such programs are selected for execution. The ROM 886 is used to store instructions and perhaps data that are read during program execution. The ROM 886 is a non-volatile memory device that typically has a small memory capacity relative to the larger memory capacity of secondary storage. The RAM 888 is used to store volatile data and perhaps to store instructions. Access to both the ROM 886 and the RAM 888 is typically faster than to the secondary storage 884.

The I/O 890 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 892 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 892 devices may enable the processor 882 to communicate with an Internet or one or more intranets. With such a network connection, it is contemplated that the processor 882 might receive information from the network, or might output information to the network in the course of performing the above-described method steps, including information such as the image 116, which is based on the object files 120. Such information, which is often represented as a sequence of instructions to be executed using the processor 882, may be received from and outputted to the network, for example, in the form of a computer data signal embodied in a carrier wave

Such information, which may include data or instructions to be executed using the processor 882 for example, may be received from and outputted to the network, for example, in the form of a computer data baseband signal or signal embodied in a carrier wave. The baseband signal or signal embodied in the carrier wave generated by the network connectivity 892 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 882 executes instructions, codes, computer programs, scripts that it accesses from hard disk, floppy disk, optical disk (these various disk based systems may all be considered the secondary storage 884), the ROM 886, the RAM 888, or the network connectivity devices 892.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. Computer readable medium containing software instruction operable when executed for providing an image for use in a mobile device, the software instructions when executed performing a method comprising:
selecting object files that include at least some code and some data for use by the mobile device;
generating components from the object files;
dividing a size of a selected one of the components by a size of a logical block to determine a number of logical blocks to allocate for the selected component;
rounding up the number of logical blocks to allocate for the selected component to an integer multiple of the size of the logical block;
establishing a unique address for the selected component based on the integer multiple of the size of the logical block; and
generating a memory layout including each unique address.

2. The computer readable medium of claim 1 wherein the object files are provided in machine language and generating the components from the object files comprises grouping modules to generate the selected component.

3. The computer readable medium of claim 2, wherein grouping the modules to generate the selected component is based on a predefined set of component definitions.

4. The computer readable medium of claim 1 wherein the size of a logical block is based on a flash memory boundary of a memory for storing the image.

5. The computer readable medium of claim 1, wherein the software instructions further comprise:
determining whether the size of the selected one of the components is larger than the size of the logical block;
partitioning a corresponding object file into modules in response to determining that the size of the selected one of the components is larger than the size of the logical block; and
replacing the selected component with components generated from the modules in response to partitioning the corresponding object file into the modules.

6. The computer readable medium of claim 1, further comprising updating the image using information stored in the memory layout.

7. The computer readable medium of claim 1 wherein generating the components from the object files comprises compressing the object files.

8. The computer readable medium of claim 1, wherein the software instructions further comprise using the memory layout to determine a location of the selected component.

9. The computer readable medium of claim 1 wherein the selected component is an application for use by the mobile device.

10. The computer readable medium of claim 1, wherein the mobile device is selected from a group consisting of a telephone, a mobile phone, a wireless mobile device, a pager, a personal digital assistant, a portable computer, a tablet computer, a laptop computer, a digital camera, a digital music player, a digital calculator, and an electronic key fob for keyless entry.

11. A system for providing an image for use in a mobile device, comprising:
an image creation system comprising a processor programmed to select object files that include at least some code and some data for use by the mobile device, the processor further programmed to generate components from the object files; and
the mobile device comprising a processor and a firmware-over-the-air engine, the firmware-over-the-air engine when executed by the processor on the mobile device divides a size of a selected one of the components by a size of a logical block to determine a number of logical blocks to allocate for the selected component, the firmware-over-the-air engine to round up the number of logical blocks to allocate for the selected component to an integer multiple of the size of the logical block and to establish a unique address for the selected component based on the integer multiple of the size of the logical block, the firmware-over-the-air engine further to generate a memory layout including each unique address and to load the components at its corresponding unique address to provide the image.

12. The system of claim 11, further comprising a system to wirelessly transfer the components to the wireless device.

13. A method for updating an image for use in a mobile device, comprising:
selecting object files that include at least some code and some data for use by the mobile device;
generating components from the object files;
dividing a size of a selected one of the components by a size of a logical block to determine a number of logical blocks to allocate for the selected component;
rounding up the number of logical blocks to allocate for the selected component to an integer multiple of the size of the logical block;
creating a delta between the object files and original object files;
forming at least one updated component from the delta and an original component;
establishing a unique address for each updated component based on the integer multiple of the size of the logical block;
generating a memory layout including each unique address; and
loading each updated component at its corresponding unique address to provide an updated image.

14. The method of claim 13 wherein the object files are provided in machine language and creating the delta between the object files and the original object files comprises analyzing machine language code.

15. The method of claim 13 wherein generating the components comprises modifying at least one of the original object files.

16. The method of claim 13 further comprising identifying which of a plurality of original components that generated an original image have been changed in the updated image based on the delta.

17. The method of claim 13, further comprising transferring components associated with the delta to the mobile device.

18. The method of claim 17, wherein transferring components associated with the delta to the mobile device comprises transferring only the components that differ from corresponding original components.

19. The method of claim 17, wherein transferring components and any modules associated with the delta to the mobile device comprises transferring the components to the mobile device using a firmware over the air process.

20. The method of claim 17, w wherein transferring components and any modules associated with the delta to the mobile device comprises transferring the components to the mobile device via a wireless interface.
